(19) United States
(12) Patent Application Publication
(10) Pub. No.: US 2005/0236899 A1
(43) Pub. Date: Oct. 27, 2005

(54) Device for data and/or energy transmission between a seat and a chassis

(76) Inventor: Harald Kazmierczak, Beilstein (DE)

Correspondence Address: KENYON & KENYON, ONE BROADWAY, NEW YORK, NY, 10004, US

(21) Appl. No.: 10/514,948

(22) PCT Filed: Feb. 17, 2003
(86) PCT No.: PCT/DE03/00465

§ 371 Date: Jun. 16, 2005

(30) Foreign Application Priority Data
May 18, 2002 (DE) 102 22 201.0
Jun. 18, 2002 (DE) 102 27 060.0
Jul. 13, 2002 (DE) 102 31 713.5

(51) Int. Cl. B60L 3/00

(52) U.S. Cl. 307/10.1

(57) ABSTRACT

A device for data and/or energy transmission between a seat and a chassis is proposed, an inductive transmission being undertaken. In this context, only at least one conductor is situated on the chassis side which is used as primary winding having only one winding. On the secondary side there is a transformer. Then, for data and energy transmission, separate conductors and transformers, respectively, are provided, even a transformer having two windings being able to be provided.

### BACKGROUND INFORMATION

The present invention relates to an invention for the transmission of data and/or energy between a seat and a chassis.

### SUMMARY OF THE INVENTION

The device according to the present invention, for transmitting data and/or energy between a seat and a chassis, by using bare conductors as a primary coil, offers a convenient way of transmitting the necessary electrical energy and data from chassis to seat inductively. This is especially important for seats that are adjusted continuously or incrementally, since the number of possible sitting positions is extremely great in such a case. In this context, it is provided in a special specific embodiment that the conductor shall be situated in a guide rail, in which the seat is movable, it being moved with the aid of a slide [as a sled]. By using two lines and also two transformers on the secondary side, it is possible to transmit data and power separately. In this context, the transformers may be made of various materials that are adapted to their use. In the case of restraint systems, the use of two transformers is particularly sensible, since for this purpose a redundancy with respect to hardware is for the greatest part necessary.

Alternatively, it is possible to provide only one transformer on the secondary side, which, however, has two windings. In this context, the first winding is provided for the transmission of the energy, and the second winding for the transmission of the data. In one further development, it may be provided that the first winding is also to be provided for transmitting an ignition command, in particular, an enable signal, that is, a redundant signal for an additional ignition command, which has already been transmitted via the second winding.

### BRIEF DESCRIPTION OF THE DRAWINGS

FIG. 1 shows a block diagram of the device according to the present invention.

FIG. 2 shows a representation in principle of the device according to the present invention.

FIG. 3 shows the slide in the guide rail.

FIG. 4 shows the slide having a receptacle for the seat.

FIG. 5 shows the slide having the receptacle and having the first parts of the yoke of the transformer situated on the side of the seat.

FIG. 6 shows the guide slide having yoke and receptacle under the stopping device in the open state.

FIG. 7 shows the same configuration in the stopped state.

FIG. 8 shows a side view of the device according to the present invention.

### DETAILED DESCRIPTION

In vehicles having removable seats, a transmission of data that are exchanged between the seat and the chassis is made possible. Plug connections, for example, or even inductive or radio transmissions may be used. The data to be transmitted are provided for restraint systems, that is, a side air bag or a seat-belt tensioning device, for an automatic child seat detection, for a passenger classification, for a belt buckle check and for a seat installation detection.

When the seats are taken out by the end customer, especially in vans or SUVs (sports utility vehicles), a simple connection for the transmission of data and/or energy must be ensured. Especially in the case of continuous seat adjustment, or in small distances, such as of only a few centimeters, transmission cables cannot be laid, of any desired length and freely, through the passenger compartment. In addition, durability demands are made on such connections. If such a connection degrades, for example a plug connection, this may have a negative effect on diagnosis functions, such as checking the firing pellet resistance having a nominal value of 2 Ohm. The diagnosis system in the air bag control device detects an error if this value is greater than 6 Ohm, and then light a warning lamp on the dashboard. This prompts a customer to visit the repair shop. Replacing or cleaning the plug, in this connection, takes care of resetting the error display. This procedure means an additional effort for the user.

According to the present invention, using an inductive transmission is now proposed, on the primary side, the chassis side, only conductors being used with regard to which the primary winding is made up of a single conductor which is preferably located in guide rails. In this context, if data and power are transmitted separately, then on the side of the seat, two primary lines and two transformers are necessary.

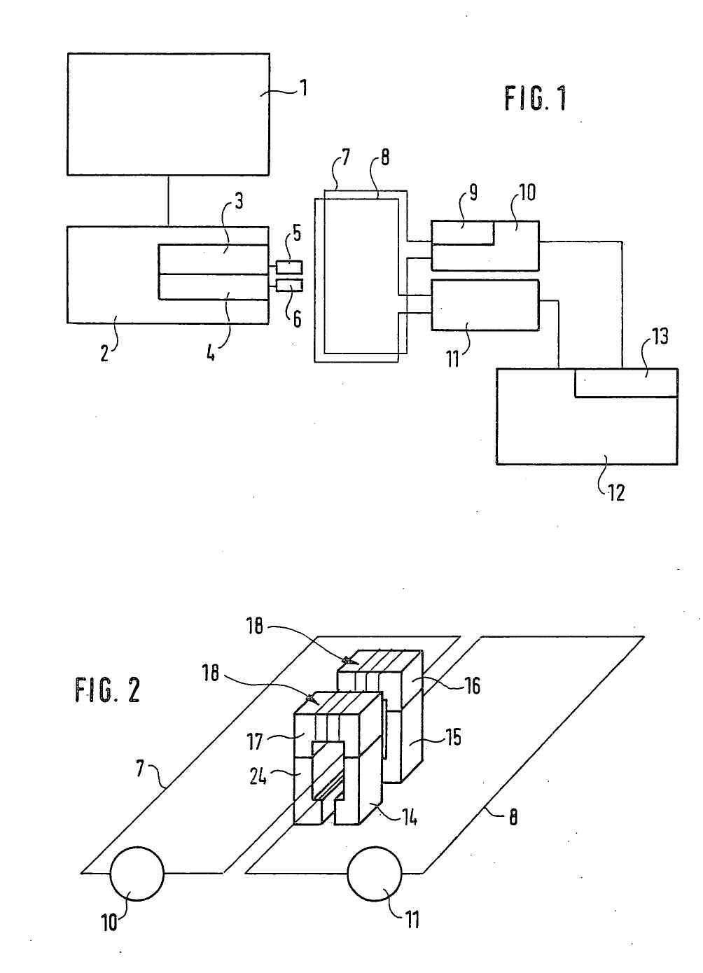

FIG. 1 shows the device of the present invention as a block diagram. In this context, an air bag control unit 12, having a redundancy path 13, transmits data from and to the chassis side which has a module 10, having a redundancy timer 9, for making available the energy for the seat, and also has a second module 11 which is used as a driver for the data transmission from and to the seat. The chassis side having modules 10 and 1 and control unit 12 are situated on the primary side. In this context, redundancy path 13 controls redundancy timer 9. An inductive transmission is used as the transmission in this case, symbolically shown conductors 7 and 8 being used as the primary coil having only one winding, and thus the energy and the data being transmitted inductively to transformers 5 and 6 that are situated on the secondary side. In this context, separate transformers for the energy and the data are provided. Alternatively, it is possible to use only one conductor and/or one transformer. Because of hardware redundancy requirements, two transformers are provided.

Transformers 5 and 6 are respectively connected to modules 3 and 4 for power and data. Modules 3 and 4 are connected to a logic 2, which, on the one hand, carries out the communications with the primary side and, on the other hand, coordinates the commands using a block 1. In block 1, restraint systems, passenger classification, automatic child seat recognition and/or seatbelt buckle monitoring are coordinated and scanned.

The path that is redundant for the ignition case is evaluated in logic 2, and the ignition is released for a limited time via the ignition circuit control. In the case of such a release, logic 2, using a controller, for example, can now interpret the actual ignition command and access the necessary means of restraint. The ignition command is passed on from air bag control unit 12 via driver 11 to winding 8. The inductive coupling via 6 and 4 provides for the transmission of the ignition command to logic 2. The ignition command includes whether a first steering wheel air bag and a second steering wheel air bag are to be triggered in a time-staggered or simultaneous fashion.

FIG. 2 shows a representation in principle of a device according to the present invention. Conductor 7 is used for the inductive transmission of the power, and, in this context, goes through two transformers and thereby their respective yokes. In this context, a generator 10 is switched into conductor 7, and it makes available the electrical energy for the seat, which is situated on the secondary side. On the other hand, in line 8 a data generator 11 is situated, which makes available the data that are to be transmitted via the transformer to the air bag control unit that is situated on the secondary side. Provision is made here for two transformers. One for the energy and a second for the data. The transformers have a yoke made up of two parts 14 and 24 or 15, onto which a second part is placed (17 or 16), on which there will then be secondary coils 18. Since, there is one winding on the primary side here, and, on the secondary side in this example three in each case, this ratio 3:1 should be taken into consideration with respect to the electrical parameters.

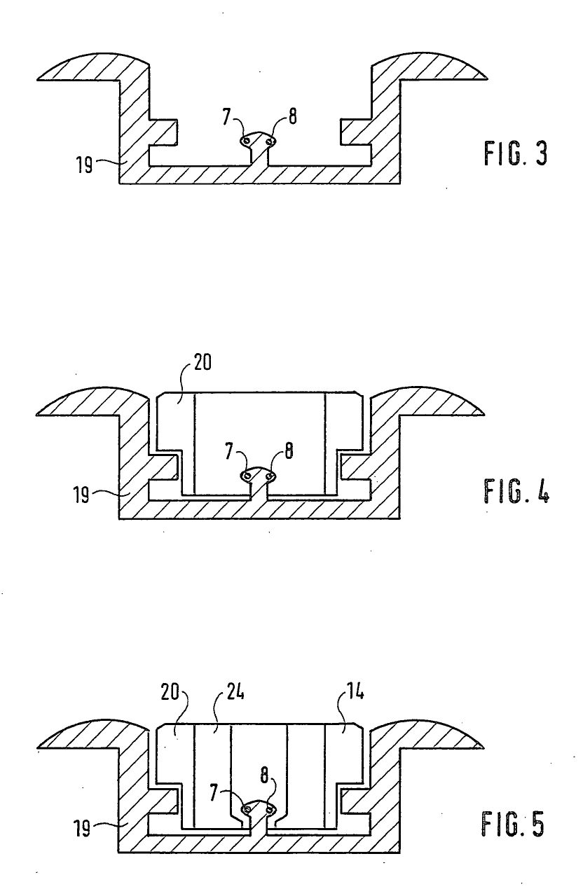

FIG. 3 shows a guide rail 19, on which the seat is able to move using a slide. A mounting support is provided centrically here, in which lines 7 and 8 are located, which are used as primary winding.

FIG. 4 shows a slide 20, which is used to accommodate the seat and which moves in rail 19. In FIG. 5 now, yoke parts 14 and 24 are added, which surround lines 7 and 8. Yoke parts 14 and 24 are separated from each other.

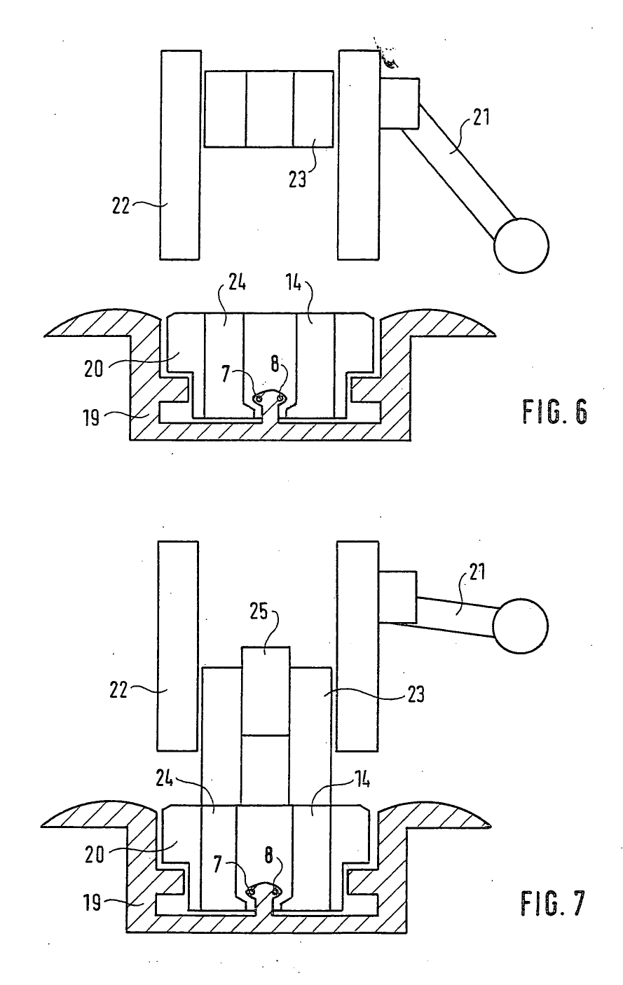

FIG. 6 shows the situation in which guide rail 19 together with slide 20 and yoke parts 24 and 14 are situated about lines 7 and 8 under an arresting device having a lever 21 and a mounting support 22.

In this context, an additional yoke part 23 is in working connection with the moving mechanism of lever 21, so that when lever 21 moves, yoke part 23 moves downwards. In this context, for stopping, lever 21 is pulled upwards. The stopping then firmly fixes the seat in the rail.

FIG. 7 shows this factual situation. Here, lever 21 has been pushed up in order to execute the stopping. In this state, the yoke part is now situated with form locking on yoke parts 24 and 14. Centrically in yoke part 23 a secondary coil part 25 having the three centrical windings is situated centrically. For simplicity's sake it was left out in FIG. 6. In the stopped state, the transformer is implemented for the secondary side, and the inductive transmission from lines 7 and 8 to transformer 23, 25, 24 and 14 is able to take place.

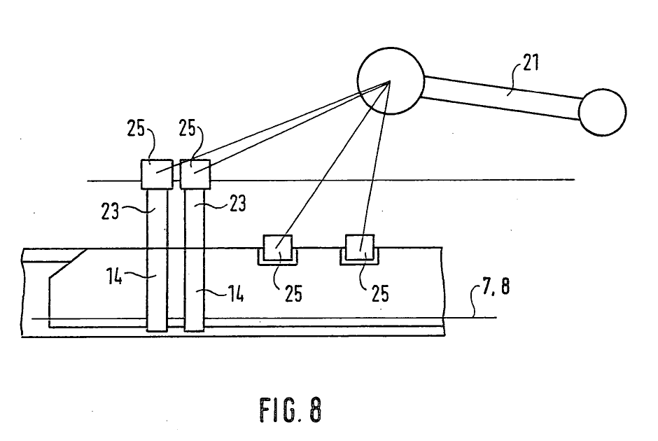

FIG. 8 additionally shows a side view of the present invention. In this context, two situations are shown: in one case, yoke 23 in the non-arrested position, that is, up, and in another case, in the arrested position, only secondary coil element 25 then still being visible. For the sake of simplicity, here only line 5 was shown.

1-6. (canceled)

7. A device for performing at least one of a data transmission and an energy transmission between a seat and a chassis, the seat being arranged in a movable fashion, comprising:
at least one conductor arranged on a chassis side; and
at least one transformer arranged on a seat side and for at least one of the data transmission and the energy.

8. The device as recited in claim 7, wherein:
the at least one conductor includes one conductor, and
the at least one transformer includes one transformer.

9. The device as recited in claim 7, wherein:
the at least one transformer includes a first winding for a transmission of energy a second winding for a transmission of data.

10. The device as recited in claim 9, wherein:
an ignition command is transmissible via the first winding.

11. The device as recited in claim 7, further comprising:
at least one rail for a slide and including the at least one conductor, the at least one rail being provided on the chassis side to accommodate the seat, wherein:
two first separate parts of a yoke of the at least one transformer are present at the slide, the two first separate parts surround the at least one conductor; and
at least one lever situated on the seat and for stopping the seat on the at least one rail, and on which two second parts of the yoke are situated, the two second parts during the stopping being positioned in a form-locking fashion with the two first separate parts.

12. The device as recited in claim 9, wherein:
the first winding and the second winding are made of different materials.
